(19) United States
(12) Patent Application Publication
(10) Pub. No.: US 2026/0281527 A1
(43) Pub. Date: Sep. 17, 2026

(54) Camera Module, Image Acquisition Method, Electronic Device, and Storage Medium

(71) Applicant: VIVO MOBILE COMMUNICATION CO., LTD., Dongguan (CN)

(72) Inventor: Jingjun Chen, Dongguan (CN)

(21) Appl. No.: 19/666,556

(22) Filed: May 4, 2026

Related U.S. Application Data
(63) Continuation of application No. PCT/CN2024/130434, filed on Nov. 7, 2024.

(30) Foreign Application Priority Data
Nov. 13, 2023 (CN) 202311512311.1

(51) Int. Cl. H04N 23/55; G02F 1/157; G02F 1/163; H04N 23/60; H04N 25/79

(52) U.S. Cl. CPC H04N 23/55; G02F 1/157; G02F 1/163; H04N 23/64; H04N 25/79; G02F 2001/1635

(57) ABSTRACT

A camera module includes a housing, a grating structure, an image sensor, and a reflection assembly. The grating structure, the image sensor, and the reflection assembly are disposed in the housing. The image sensor includes a first photosensitive layer and a second photosensitive layer that are stacked. The grating structure is disposed above the image sensor, and when incident light reaches the grating structure, a first portion of the incident light passes through the grating structure, and then reaches the first photosensitive layer of the image sensor, and a second portion of the incident light diffracts through the grating structure to the reflection assembly, and then reaches the second photosensitive layer of the image sensor after being reflected by the reflection assembly.

### CROSS-REFERENCE TO RELATED APPLICATIONS

This application is a Bypass Continuation Application of International Patent Application No. PCT/CN2024/130434 filed Nov. 7, 2024, and claims priority to Chinese Patent Application No. 202311512311.1 filed Nov. 13, 2023, the disclosures of which are hereby incorporated by reference in their entireties.

### BACKGROUND OF THE INVENTION

### Field of the Invention

This application pertains to the field of photographing technologies, and relates to a camera module, an image acquisition method, an electronic device, an apparatus, and a storage medium.

### Description of Related Art

Generally, to improve clarity of a photographed image, an electronic device may obtain an image with relatively high clarity by increasing the number of pixels in an image sensor. However, for an image sensor of a same size, a larger number of pixels means a smaller area of a single pixel, which results in a reduced light-sensing capability of the image sensor and a narrowed dynamic range.

### SUMMARY OF THE INVENTION

Embodiments of this application provide a camera module, an image acquisition method, an electronic device, an apparatus, and a storage medium.

According to a first aspect, an embodiment of this application provides a camera module. The camera module includes a housing, a grating structure, an image sensor, and a reflection assembly. The grating structure, the image sensor, and the reflection assembly are disposed in the housing. The image sensor includes a first photosensitive layer and a second photosensitive layer that are stacked. The grating structure is disposed above the image sensor, and when incident light reaches the grating structure, a first portion of the incident light passes through the grating structure, and then reaches the first photosensitive layer of the image sensor, and a second portion of the incident light diffracts through the grating structure to the reflection assembly, and then reaches the second photosensitive layer of the image sensor after being reflected by the reflection assembly.

According to a second aspect, an embodiment of this application provides an electronic device, and the electronic device includes the camera module according to the first aspect.

According to a third aspect, an embodiment of this application provides an image acquisition method, performed by the electronic device according to the second aspect. The image acquisition method includes: controlling a grating structure of a camera module to diffract a first portion of incident light to a second photosensitive layer of an image sensor, and acquiring first image data by using the image sensor; controlling the grating structure to transmit a second portion of the incident light to a first photosensitive layer of the image sensor, and acquiring second image data by using image sensor; and obtaining third image data based on the first image data and the second image data.

According to a fourth aspect, an embodiment of this application provides an image acquisition apparatus, including the camera module according to the first aspect, and the image acquisition apparatus further includes an acquisition module and a processing module. The acquisition module is configured to: control a grating structure of the camera module to diffract a first portion of incident light to a second photosensitive layer of an image sensor, and acquire first image data by using the image sensor; and control the grating structure to transmit a second portion of the incident light to a first photosensitive layer of the image sensor, and acquire second image data by using the image sensor. The processing module is configured to obtain third image data based on the first image data and the second image data that are acquired by the acquisition module.

According to a fifth aspect, an embodiment of this application provides an electronic device. The electronic device includes a processor and a memory, the memory stores a program or instructions capable of being run on the processor, and when the program or instructions are executed by the processor, the steps of the method according to the third aspect are implemented.

According to a sixth aspect, an embodiment of this application provides a non-transitory readable storage medium. The non-transitory readable storage medium stores a program or instructions, and when the program or instructions are executed by a processor, the steps of the method according to the third aspect are implemented.

According to a seventh aspect, an embodiment of this application provides a chip. The chip includes a processor and a communication interface, the communication interface is coupled to the processor, and the processor is configured to run a program or instructions, to implement the method according to the third aspect.

According to an eighth aspect, an embodiment of this application provides a computer program product. The program product is stored in a non-transitory storage medium, and the program product is executed by at least one processor to implement the method according to the third aspect.

### BRIEF DESCRIPTION OF THE DRAWINGS

FIG. 1 is a first schematic structural diagram of a camera module according to an embodiment of this application;

FIG. 2A is a first schematic structural diagram of a grating structure according to an embodiment of this application;

FIG. 2B is a second schematic structural diagram of a grating structure according to an embodiment of this application;

FIG. 2C is a third schematic structural diagram of a grating structure according to an embodiment of this application;

FIG. 2D is a fourth schematic structural diagram of a grating structure according to an embodiment of this application;

FIG. 3 is a second schematic structural diagram of a camera module according to an embodiment of this application;

FIG. 4 is a schematic structural diagram of a photosensitive layer according to an embodiment of this application;

FIG. 5 is a first schematic diagram of a circuit structure of a logic circuit layer according to an embodiment of this application;

FIG. 6 is a second schematic diagram of a circuit structure of a logic circuit layer according to an embodiment of this application;

FIG. 7 is a third schematic structural diagram of a camera module according to an embodiment of this application;

FIG. 8 is a first schematic flowchart of an image acquisition method according to an embodiment of this application;

FIG. 9 is a second schematic flowchart of an image acquisition method according to an embodiment of this application;

FIG. 10 is a first schematic structural diagram of an image acquisition apparatus according to an embodiment of this application;

FIG. 11 is a first schematic diagram of a hardware structure of an electronic device according to an embodiment of this application; and

FIG. 12 is a second schematic diagram of a hardware structure of an electronic device according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

In the specification of this application, terms such as “first” and “second” are used for distinguishing similar objects, and are not used to describe a particular order or sequence. It should be understood that, the terms used in such a way are interchangeable in proper circumstances, so that the embodiments of this application can be implemented in an order other than the order illustrated or described herein. Objects classified by “first”, “second”, and the like are usually of a same type, and the number of objects is not limited. For example, there may be one or more first objects. In addition, in the description, “and/or” represents at least one of connected objects, and a character “/” generally represents an “or” relationship between associated objects.

Terms “at least one (item)” and “at least one” in the specification of this application refer to any one, any two, or a combination of more than two of the objects included in the term. For example, at least one (item) of a, b, and c may represent “a”, “b”, “c”, “a and b”, “a and c”, “b and c”, and “a, b, and c”, where a, b, and c may be singular or plural. Similarly, “at least two (items)” means two or more, and a meaning thereof is similar to that of “at least one (item)”.

An image sensor, an image acquisition method, an electronic device, an apparatus, and a non-transitory storage medium provided in the embodiments of this application are described in detail below by using exemplary embodiments and application scenarios thereof with reference to the accompanying drawings.

Currently, with the development of electronic technologies, electronic devices are provided with increasingly diverse functions. For example, the electronic device may capture images by using an image sensor to obtain the captured images. The image sensor is a device for converting an optical image into an electronic signal, and is widely used in a digital camera and another electronic optical device. Currently, image sensors are mainly classified into two types: charge-coupled devices (CCD) and complementary metal oxide semiconductor active pixel sensors. The CMOS active pixel sensor is an active pixel sensor that uses a CMOS semiconductor. There is a corresponding circuit near each photoelectric sensor that directly converts optical energy into a voltage signal. Unlike the CCD, the CMOS active pixel sensor does not involve signal charges. An analog-to-digital converter may also be required on a mainboard to convert its output signal into a digital signal. Pixels of the CMOS sensor can only sense luminance. To sense color, a color filter array (CFA) needs to be overlaid on the pixels. The CFA functions by filtering out light of another wavelength band and allowing light of a desired wavelength band to pass through, and then photoelectric conversion is performed on the pixels. In this way, the pixels can sense color. However, this approach wastes light energy. In addition, in this manner, a color sensing capability is relatively coarse.

Currently, the camera market in electronic devices is becoming increasingly competitive, especially in terms of photographing, where different terminals compete intensely, mainly in improving image clarity. However, improving clarity generally requires increasing the number of pixels. For sensors of a same size, a larger number of pixels means a smaller individual pixel area, which brings a series of negative effects, such as a reduced light sensitivity of the sensor and narrowed dynamic range. To resolve such problems, the industry typically uses algorithm solutions such as a single-frame interpolation algorithm, multi-frame synthesis, and multi-camera fusion to enhance the clarity.

Each of these solutions has disadvantages. For the single-frame interpolation algorithm, while some improvement can be achieved, the number of actual photosensitive pixels does not increase, and therefore, enhancement is limited. In a high-frequency (detailed) scenario, an interpolation error may even occur. For a multi-frame algorithm, a typical example is a pixel shift technology, that is, the sensor moves by one pixel in each of four directions, acquiring an image once in each move. Generally, four such movements are performed to effectively increase actual photosensitive pixels, and then multi-frame synthesis is performed to improve resolution. This manner can improve resolution theoretically, but actual operations are very difficult. It is mainly difficult to enable the sensor to move by a distance of only one pixel each time. Consequently, a final effect is poor and the clarity of a photographed image obtained by the electronic device remains unsatisfactory. Multi-frame fusion and multi-camera fusion essentially involve fusing a plurality of images, extracting sharpness and texture from each image, and overlaying a plurality of frames to enhance clarity of the final image. However, multi-frame capture increases power consumption of a camera, and during multi-frame photographing, a user is required to remain still, otherwise a fusion effect is compromised. In summary, these solutions still have significant limitations.

In the camera module, the image acquisition method, the electronic device, the apparatus, and the non-transitory storage medium provided in this application, a grating structure is disposed in a camera module. Through control of a grating parameter of the grating structure, the grating structure can have both a transmission function and a diffraction function, so that a first portion of incident light can be controlled to reach a first photosensitive layer of an image sensor through the grating structure, and a second portion of the incident light can be controlled to be diffracted to a reflection assembly, and then reach a second photosensitive layer of the image sensor after being reflected by the reflection assembly. Because in the embodiments of this application, the image sensor is capable of double-sided light sensing, the number of photosensitive pixels is increased without changing a pixel size of the image sensor, thereby significantly improving a light-sensing capability of the image sensor and ultimately enhancing clarity of a photographed image.

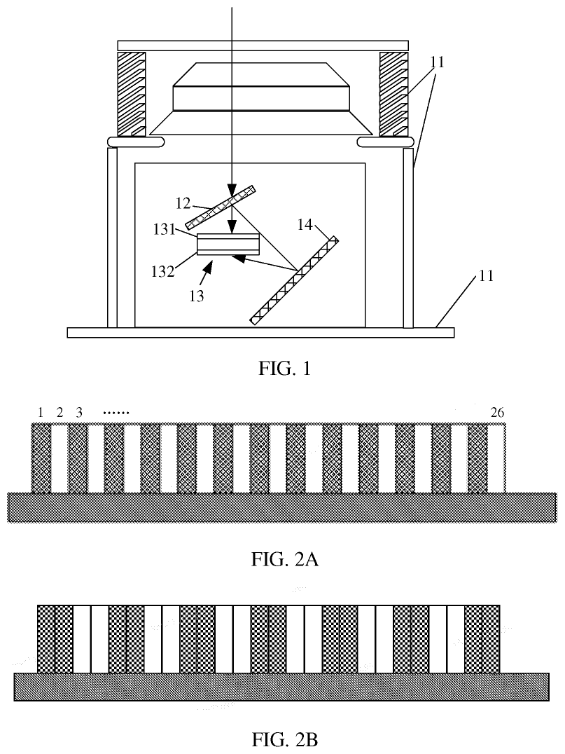

An embodiment of this application provides an image sensor. FIG. 1 is a schematic structural diagram of a camera module according to an embodiment of this application. A camera module 10 includes a housing 11, a grating structure 12, an image sensor 13, and a reflection assembly 14.

For example, the grating structure 12, the image sensor 13, and the reflection assembly 14 are disposed in the housing. The image sensor 13 includes a first photosensitive layer 131 and a second photosensitive layer 132 that are stacked.

For example, the grating structure 12 is disposed above the image sensor 13. When incident light reaches the grating structure 12, a first portion of the incident light passes through the grating structure 12, and then reaches the first photosensitive layer 131 of the image sensor 13. A second portion of the incident light diffracts through the grating structure 12 to the reflection assembly 14, and then reaches the second photosensitive layer 132 of the image sensor 13 after being reflected by the reflection assembly 14.

In some embodiments of this application, the housing may be a plastic housing or a metal housing.

In some embodiments of this application, the grating structure may be a controllable micro-/nano-structure, and the controllable micro-/nano-structure is used to diffract light.

It may be understood that the foregoing controllable micro-/nano-structure is an optical element with a periodic structure. A period may be formed by raised peaks and recessed valleys embossed on a surface of a material, causing a periodic variation in a refractive index n within the material. This period is usually on a micrometer or nanometer scale, which is on the same order of magnitude as a wavelength (450 nm to 700 nm) of visible light, so that effective deflection control can be generated for the light.

In this embodiment of this application, the foregoing controllable micro-/nano-structure may be used to diffract light corresponding to a part of a wavelength band of the light.

For example, a “beam-splitting” principle of the controllable micro-/nano-structure is as follows. Assuming that incident light is monochromatic green light, a diffraction grating splits the incident light into several diffraction orders, each diffraction order propagating in a different direction, including reflected diffraction (R0, R±1, R±2, . . . ) and transmitted diffraction (T0, T±1, T±2, . . . ). A diffraction angle (θₘ, m=±1, ±2, . . . ) corresponding to each diffraction order is determined by an incident angle (θ) of the light and a grating period (Λ). By designing grating parameters (a material refractive index n, a grating shape, thickness, a duty cycle, and the like), diffraction efficiency of a particular diffraction order (that is, a particular direction) can be optimized to a highest level, so that most of the light propagates mainly along that direction after diffraction.

In some embodiments of this application, both the diffraction angle and the diffraction efficiency are controlled by a grating parameter. In this case, an effect of controlling beam-splitting can be achieved by designing a grating with variable parameters. In the following grating equation, mλ=d(sin α+sin βₘ). where d is a grating spacing, also referred to as a grating constant, m is an integer whose value is 0, ±1, or the like. The diffraction angle is βₘ, and a is the incident angle. λ is the wavelength of the light.

For example, with an incident angle of 30°, a diffraction angle of 31°, and light in a 400 nm wavelength band, 0.515+0.5=0.4/d, and in this case, d=0.394 m.

In some embodiments of this application, the grating structure includes at least two liquid crystal assemblies. A thickness of each of the liquid crystal assemblies is greater than or equal to 1 nm.

For example, the size of the grating structure is greater than or equal to the size of the image sensor.

For example, the material of each of the at least two liquid crystal assemblies is an electrochromic material.

For example, the camera module may change a structure of the grating structure by adjusting a voltage across both ends of the grating structure, so that the light is diffracted to a preset angle.

For example, the grating structure may include M liquid crystal assemblies distributed in an array, and M is a positive integer. For example, a value of M may be 1, 2, 3, 4, 5, or the like.

For example, pixel structures and grating structures are disposed in a one-to-one manner, and transmittance of each liquid crystal assembly is determined by using electrical information applied to the liquid crystal assembly.

For example, the camera module controls electrical information applied to each liquid crystal assembly, so that each electronically controlled liquid crystal assembly is transparent, opaque, or semi-transparent.

The grating structure is described below by using an example.

For example, it is assumed that one grating structure includes 26 liquid crystal assemblies distributed in a single row. By separately controlling a current applied to the 26 liquid crystal assemblies, when a width value of the liquid crystal assembly is 10 nm, the grating structure may be controlled to form a series of gratings whose grating constants are respectively 10*2P nm, where P is a positive integer.

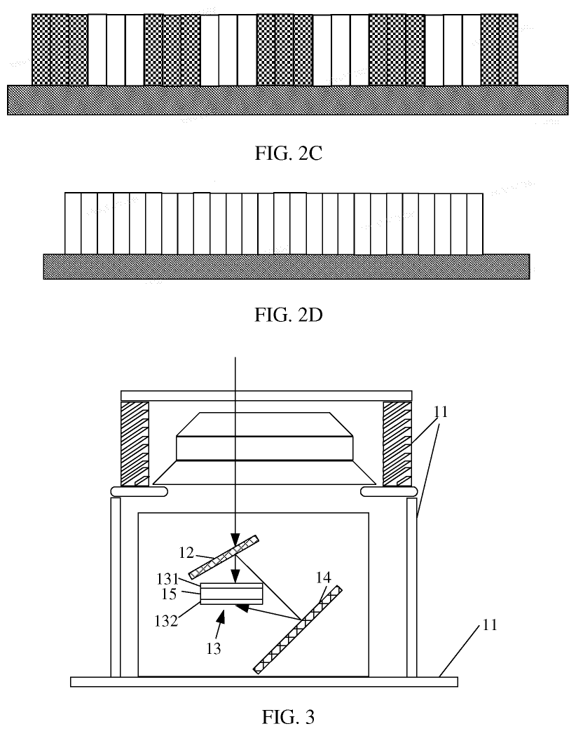

For example, the grating structure may constitute a grating whose grating constant is 20 nm shown in FIG. 2A, a grating whose grating constant is 40 nm shown in FIG. 2B, or a grating whose grating constant is 60 nm shown in FIG. 2C.

Certainly, if a grating is not required, all liquid crystal assemblies may be controlled to be fully transparent, and in this case, the grating structure is merely a planar transmissive lens, as shown in FIG. 2D.

It may be learned that, in FIG. 2A to FIG. 2D, a liquid crystal assembly shown in a filled region is opaque, such as a liquid crystal assembly labeled “1” in FIG. 2A, while a liquid crystal component shown in an unfilled region is fully transparent, such as a liquid crystal component labeled “2” in FIG. 2A.

For example, taking one liquid crystal assembly as an example: when no voltage is applied to both ends of the liquid crystal assembly, small droplets in the liquid crystal assembly are in a disordered state. When light enters, the refractive index of the droplets differs significantly from that of a substrate, causing scattering as the light passes through, and the grating exhibits an opaque state (that is, the light cannot reach a first photosensitive layer). When a voltage is applied to both ends, the liquid crystal assembly may adjust small droplets in a liquid crystal layer based on magnitude of the voltage, so that a refractive index of the droplets becomes closer to that of the substrate. In other words, when light enters, the light can reach the first photosensitive layer, and the image sensor can then acquire images through photosensitive pixels.

For example, the voltage may be 0 V to 2.8 V.

For example, the foregoing electrical information may be a voltage or a current.

For example, the transmittance of the liquid crystal assembly is positively or negatively correlated with a current applied to the liquid crystal assembly, and may be determined based on the material of the liquid crystal assembly.

For example, width of the liquid crystal assembly along a direction perpendicular to an optical axis may be referred to as thickness of an electrically controlled liquid crystal assembly, and the thickness may be determined based on an actual design requirement. For example, the thickness of the electrically controlled liquid crystal assembly may be 10 nm, 8 nm, or any other possible width. In other words, the thickness of the electrically controlled liquid crystal assembly is a length of a short side, when viewed in a direction of the optical axis.

For example, liquid crystal assemblies in the grating structure may be arranged in one or more rows, which may be determined according to an actual use requirement.

In some embodiments of this application, the image sensor may be either of the following: a CMOS sensor or a CCD sensor.

In some embodiments of this application, the reflection assembly may be a reflecting mirror.

In some embodiments of this application, the first photosensitive layer includes green pixel units, and the second photosensitive layer includes red pixel units and blue pixel units.

In some embodiments of this application, the first photosensitive layer may consist entirely of green pixel units, and the second photosensitive layer may include only red pixel units and blue pixel units.

For example, the first photosensitive layer includes a first optical filter layer.

For example, the first optical filter layer may be an optical filter array including a plurality of optical filters.

It may be understood that each of the plurality of optical filters in the first filter layer corresponds to one photosensitive pixel in the first photosensitive layer.

For example, the first optical filter layer may be used to transmit green light.

For example, the photosensitive pixel may be a photodiode.

In some embodiments of this application, the second photosensitive layer includes a second optical filter layer.

For example, the second optical filter layer may be an optical filter array including a plurality of optical filters.

It may be understood that each of the plurality of optical filters in the second optical filter layer corresponds to one photosensitive pixel in the second photosensitive layer.

For example, the second optical filter layer may be used to transmit red light and blue light.

For example, the optical filter may be an RGB filter.

In the camera module provided in this embodiment of this application, a grating structure is disposed in the camera module. Through control of a grating parameter of the grating structure, the grating structure can have both a transmission function and a diffraction function, so that a first portion of incident light can be controlled to reach a first photosensitive layer of an image sensor through the grating structure, and a second portion of the incident light can be controlled to be diffracted to a reflection assembly, and then reach a second photosensitive layer of the image sensor after being reflected by the reflection assembly. Because in the embodiments of this application, the image sensor is capable of double-sided light sensing, the number of photosensitive pixels is increased without changing the pixel size of the image sensor, thereby significantly improving a light-sensing capability of the image sensor and ultimately enhancing clarity of a photographed image.

In some embodiments of this application, with reference to FIG. 1, as shown in FIG. 3, photosensitive units in the first photosensitive layer 131 are disposed opposite to photosensitive units in the second photosensitive layer 132, and a logic circuit layer 15 is disposed between the first photosensitive layer 131 and the second photosensitive layer 132.

In this embodiment of this application, the logic circuit layer is separately electrically connected to the first photosensitive layer and the second photosensitive layer.

It may be understood that the photosensitive units in the first photosensitive layer in the image sensor are disposed opposite to the photosensitive units in the second photosensitive layer. In other words, the image sensor is a double-sided sensor, and the number of photosensitive units can be significantly increased compared with a single-sided image sensor.

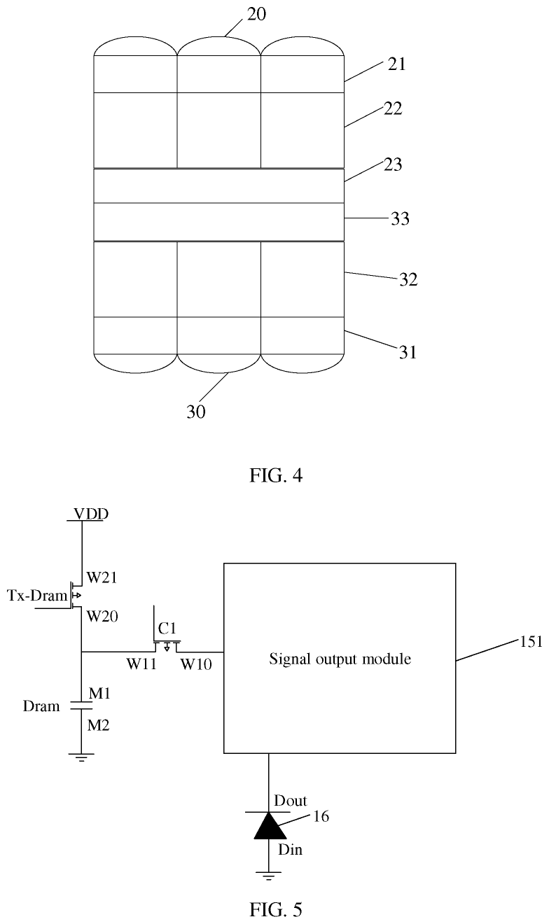

For example, as shown in FIG. 4, the first photosensitive layer includes a microlens 20, a first optical filter layer 21, a first photosensitive pixel layer 22, and a first metal wiring layer 23. The second photosensitive layer includes a microlens 30, a second optical filter layer 31, a second photosensitive pixel layer 32, and a second metal wiring layer 33.

For example, the metal wiring layer may be a printed circuit board (PCB) or a flexible printed circuit board.

It should be noted that the first photosensitive layer receives only green light signals, and the second photosensitive layer receives only red light signals and blue light signals.

In this embodiment of this application, a double-sided photosensitive layer is disposed on the electronic device, so that the number of photosensitive pixels in the image sensor can be increased when the size of the image sensor is fixed, and a photosensitive capability of the image sensor is significantly improved, thereby improving image quality of an image photographed by the electronic device.

In some embodiments of this application, as shown in FIG. 5, the first photosensitive layer and the second photosensitive layer include photodiodes 16. The logic circuit layer 15 includes a signal output module 151, a first switch C1, a second switch Tx-Dram, and a first capacitor Dram. An output terminal Dout of the photodiode 16 is connected to the signal output module 151, and the signal output module 151 is connected to a first terminal W10 of the first switch C1; and a second terminal W11 of the first switch C1 and a first terminal W20 of the second switch Tx-Dram are respectively connected to a first terminal M1 of the first capacitor Dram, a second terminal M2 of the first capacitor Dram is grounded, and a second terminal W21 of the second switch Tx-Dram is connected to a power supply terminal VDD.

In this embodiment of this application, a voltage signal output by the signal output module is associated with a voltage signal generated by the photodiode and states of the first switch and the second switch. In other words, magnitude of the voltage signal output by the signal output module may be controlled by using the first switch and the second switch.

For example, the signal output module is configured to obtain an image electrical signal corresponding to the photodiode, and the first switch, the second switch, and the first capacitor are configured to amplify the image electrical signal.

For example, the first switch and the second switch may be a transistor or a field effect transistor.

For example, the transistor may be a silicon transistor or a germanium transistor, and the field effect transistor may be a junction field effect transistor or an insulated-gate field effect transistor. This may be determined according to an actual use requirement, and is not limited in this embodiment of this application.

In some embodiments of this application, the logic circuit layer includes a first circuit layer and a second circuit layer, the first circuit layer corresponds to the first photosensitive layer, and the first circuit layer is a logic circuit layer in a related technology. Details are not described herein again. The second circuit layer corresponds to the second photosensitive layer, and the second photosensitive layer includes the signal output module, the first switch, the second switch, and the first capacitor. In other words, an optical signal collected by the first photosensitive layer does not need to be amplified.

In some embodiments of this application, the first capacitor may be any one of the following: a mica capacitor, a ceramic capacitor, an electrolytic capacitor, or the like. This may be determined according to an actual use requirement, and is not limited in this embodiment of this application.

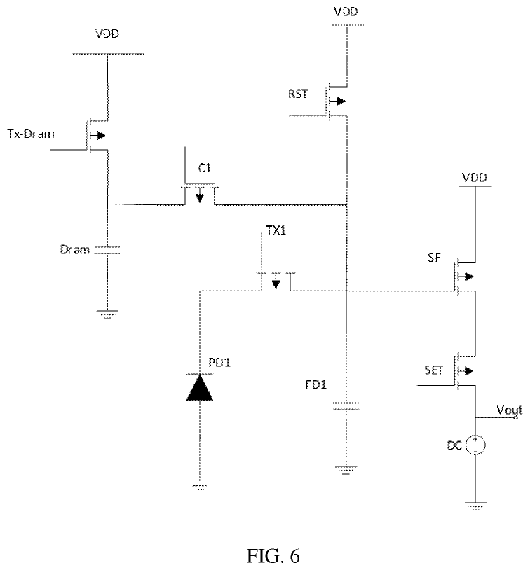

In some embodiments of this application, with reference to FIG. 5, as shown in FIG. 6, the signal output module 151 includes a source follower SF, a row select transistor SET, a first transfer transistor TX1, a second capacitor FD1, and a reset transistor RST. A drain of the source follower SF is connected to a first power supply, a source of the source follower is connected to a drain of the row select transistor SET, and a gate of the source follower SF is separately connected to a drain of the first transfer transistor TX1, a source of the reset transistor RST, and a first terminal of the second capacitor FD1. A drain of the row select transistor SET is configured to output an amplified image signal. A source of the first transfer transistor TX1 is connected to a cathode of the photodiode PD1, and an anode of the photodiode PD1 is grounded. A second terminal of the second capacitor FD1 is grounded. A drain of the reset transistor RST is connected to the first power supply.

For example, the first power supply and the second power supply may be direct-current power supplies.

As an example for description, a voltage and a current of the first power supply may be the same as or different from a voltage and a current of the second power supply. This may be determined according to an actual use requirement, and is not limited in this embodiment of this application.

For example, the source follower may be a field effect transistor.

For example, the row select transistor may be a field effect transistor.

In this embodiment of this application, the first transfer transistor may be a silicon transistor or a germanium transistor.

In this embodiment of this application, the second capacitor may be any one of the following: a mica capacitor, a ceramic capacitor, an electrolytic capacitor, or the like. This may be determined according to an actual use requirement, and is not limited in this embodiment of this application.

An image signal amplification circuit involved in this embodiment of this application is explained and described below. The following steps 20 to 23 may be used for implementation.

Step 20: Reset a pixel circuit. Both RST and TX1 are turned on to clear electrons in PD1 and FD1, and Tx-Dram is enabled to clear electrons in Dram. In this case, all electrons in the pixel circuit are cleared.

Step 21: Controlled exposure of pixels. Both Tx-Dram and RST are turned off. PD1 begins controlled exposure. Electron-hole pairs generated by light irradiation are separated due to the existence of an electric field in PD1, with electrons moving toward an n-region and holes moving toward a p-region. Photoelectrons are generated in PD1.

Step 22: Transfer of PD charges. Only TX1 is turned on, and charges are completely transferred from a photosensitive region to FD1 for reading. The mechanism here is similar to charge transfer in a CCD. In this case, photoelectrons in PD are completely transferred to FD1. If charges in FD1 are to be controlled, a switch C1 may also be briefly switched on and off in a process of enabling TX1, and diversion of photoelectrons is controlled by controlling on/off time of C1.

For example, if TX1 is turned on for 10 s, electrons in PD can be fully transferred to FD1, thereby obtaining 1000 electrons. If C1 is turned on for only 1 s in a process of turning on TX1, 100 electrons are transferred to D-ram, and there are only 900 electrons in FD1.

Certainly, some voltages/electrons can also be pre-stored in Dram through VDD. When pixels transfer electrons, that is, when Tx1 is turned on, C1 can also be turned on to introduce some electrons into FD1. A same principle is applied and is not described herein again.

Step 23: Signal level readout. Next, a voltage signal on FD1 is transmitted to a Vout output terminal through an SF, that is, a source follower. After analog amplification and ADC conversion, a digitized signal is obtained.

For example, assuming the energy of the diffracted red and blue light is 20% of original red and blue light energy, it is necessary to pre-store a voltage in Dram that is four times the pixel voltage on the second photosensitive layer. When a pixel on the second photosensitive layer is read out, the switch C1 of Dram is also turned on, allowing an image signal output by the second photosensitive layer to match an image signal corresponding to normal red and blue light. This improves a fusion effect between an image output by the first photosensitive layer and an image output by the second photosensitive layer, resulting in higher image clarity.

In this embodiment of this application, because the second photosensitive layer acquires diffracted light signals, light intensity is inevitably reduced after diffraction, leading to lower energy in a photographed image and affecting image clarity. Therefore, by amplifying the image signal by using a signal amplification circuit, the energy of the photographed image can be restored to a level of direct light, thereby ensuring clarity of an image photographed by the electronic device.

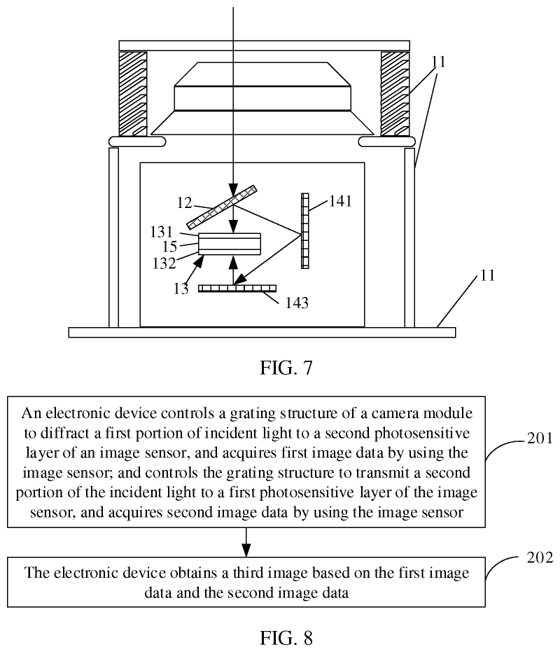

In some embodiments of this application, with reference to FIG. 3, as shown in FIG. 7, the reflection assembly 14 includes a first reflection member 141 and a second reflection member 142.

For example, an angle between a plane of the first reflection member and a plane of the grating structure is less than 90°.

For example, the second reflection member is disposed opposite to the second photosensitive layer.

For example, the second portion of the incident light diffracted by the grating structure reaches the second photosensitive layer after being successively reflected by the first reflection member and the second reflection member.

For example, the first reflection member and the second reflection member may be single-sided reflecting glass.

In this embodiment of this application, the electronic device may diffract light into the second photosensitive layer through the first reflection member and the second reflection member. In this way, the camera module can obtain a plurality of images based on a double-sided sensor, to obtain an image with relatively high clarity based on the plurality of images.

The image acquisition method provided in the embodiments of this application may be performed by an image acquisition apparatus, and the image acquisition apparatus may be an electronic device or a functional module in the electronic device. The following uses an electronic device as an example to describe the technical solutions provided in the embodiments of this application. The electronic device includes the camera module described in the foregoing embodiment.

An image acquisition method is provided in an embodiment of this application. FIG. 8 is a flowchart of an image acquisition method according to an embodiment of this application. As shown in FIG. 8, the image acquisition method provided in this embodiment of this application may include the following step 201 and step 202.

Step 201: An electronic device controls a grating structure of a camera module to diffract a first portion of incident light to a second photosensitive layer of an image sensor, and acquires first image data by using the image sensor; and controls the grating structure to transmit a second portion of the incident light to a first photosensitive layer of the image sensor, and acquires second image data by using the image sensor.

In this embodiment of this application, when light is incident on the image sensor, the electronic device diffracts a first portion of the incident light to the second photosensitive layer by using the grating structure of the camera module in the electronic device, acquires the first image data by using the image sensor, transmits the light to the first photosensitive layer by using the grating structure, and acquires the second image data by using the image sensor.

In this embodiment of this application, the first image data may include image data corresponding to a red channel and a blue channel, and the second image data may include image data corresponding to a green channel.

It may be understood that, with reference to the foregoing embodiment, there is a first photosensitive pixel array below the first photosensitive layer, and the electronic device may acquire the first image data by using the first photosensitive pixel array and a first logic circuit layer corresponding to the first photosensitive pixel array, to obtain a first image. There is a second photosensitive pixel array below the second photosensitive layer, and the electronic device may obtain the second image data by using the second photosensitive pixel array and a second logic circuit layer corresponding to the second photosensitive pixel array, to obtain a second image.

In this embodiment of this application, the electronic device may change a grating constant of the grating structure, so that a first portion of light is diffracted to a reflection assembly, and is reflected by the reflector twice, and a second portion of the light is projected to the second photosensitive layer of the image sensor, which is briefly referred to as a surface B below. In addition, some light is transmitted to the first photosensitive layer of the image sensor by using the grating structure, which is briefly referred to as a surface A below. In this way, the electronic device may obtain two images, that is, the first image and the second image.

It should be noted that an image size of the first image is the same as an image size of the second image.

In some embodiments of this application, “an electronic device controls a grating structure of a camera module to diffract a portion of incident light to a second photosensitive layer of an image sensor, and acquires first image data by using the image sensor” in step 201 may be implemented by using the following step 201a and step 201b.

Step 201a: The electronic device determines a first grating constant based on a wavelength of the first portion of the incident light and an incident angle and a diffraction angle of the first portion of the incident light on the grating structure.

It may be understood that light of each color in natural light corresponds to a wavelength range. The electronic device may pre-store a relationship between a wavelength range and light, to obtain the wavelength of the first portion of the incident light.

It should be noted that the foregoing light is natural light.

In this embodiment of this application, the diffraction angle is a preset angle, and the diffraction angle is related to a positional relationship between the grating structure and the reflection assembly.

It should be noted that for a process of determining the first grating constant, reference may be made to the foregoing embodiment. To avoid repetition, details are not described herein again.

Step 201b: The electronic device adjusts a grating constant of the grating structure to the first grating constant, so that the grating structure diffracts a portion of the incident light to the second photosensitive layer.

It should be noted that for a process in which the electronic device diffracts a portion of the incident light to the second photosensitive layer, reference may be made to the foregoing embodiment. To avoid repetition, details are not described herein again.

In this embodiment of this application, the electronic device may diffract a portion of the light by using the grating structure, so that different image data can be obtained, and then different image data can be fused to obtain an image with relatively high clarity. In this way, clarity of an image photographed by the electronic device is improved.

Step 202: The electronic device obtains third image data based on the first image data and the second image data.

In this embodiment of this application, the electronic device may fuse the first image data and the second image data to obtain the third image data.

In some embodiments of this application, the first photosensitive layer includes green pixel units, and the second photosensitive layer includes red pixel units and blue pixel units. The first image data includes red-channel image data and blue-channel image data, and the second image data includes green-channel image data.

It may be understood that in this application, the use of a double-sided image sensor increases the number of pixels in the image sensor, and a surface A of the image sensor accepts only green light. Definition in an actual photographing environment is mainly presented by green light. Compared with a conventional sensor, the number of pixels receiving green light is increased, and therefore, definition of an image A output from the surface A is significantly improved. On the surface B, the number of pixels receiving red light and blue light is also increased compared with the number of pixels receiving red light and blue light in a conventional sensor, thereby significantly enhancing the clarity of red and blue colors in an image output by the conventional sensor. Therefore, after the first image and the second image are fused, an image with better clarity and better color can be obtained.

For example, step 202 may be implemented by the following step 202a.

Step 202a: The electronic device fuses the red-channel image data, the blue-channel image data, and the green-channel image data to obtain the third image data.

In this embodiment of this application, the electronic device may fuse the red-channel image data, the blue-channel image data, and the green-channel image data based on a preset configuration of the three primary colors, to obtain the third image data.

In the image acquisition method provided in this embodiment of this application, during image acquisition, the grating structure is controlled to diffract a first portion of incident light to a second photosensitive layer of the image sensor, and first image data is acquired, and the grating structure is controlled to transmit a second portion of the incident light to a first photosensitive layer of the image sensor, and second image data is acquired. Finally, third image data may be obtained based on the first image data and the second image data. Because the third image data is generated by fusing the first image data and the second image data, clarity of a final image can be improved.

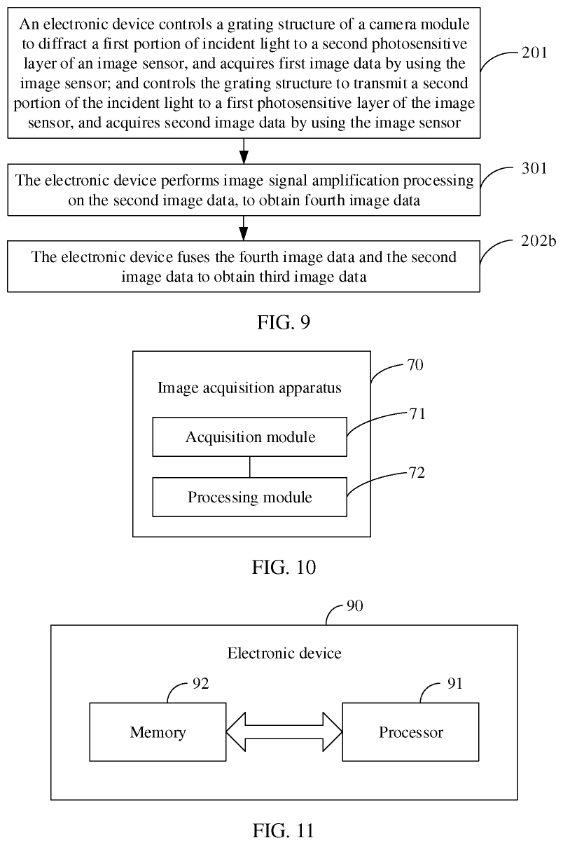

In some embodiments of this application, with reference to FIG. 8, as shown in FIG. 9, before step 202, the image acquisition method provided in this embodiment of this application further includes the following step 301, and the foregoing step 202 may be implemented by using the following step 202b.

Step 301: The electronic device performs image signal amplification processing on the first image data, to obtain fourth image data.

In this embodiment of this application, the electronic device may perform image signal amplification processing on the first image data by using the foregoing amplification circuit to obtain a fourth image.

It should be noted that for an implementation process, reference may be made to the foregoing embodiment. To avoid repetition, details are not described herein again.

Step 202b: The electronic device fuses the fourth image data and the second image data to obtain the third image data.

In this embodiment of this application, because the first image data is obtained through diffraction by using the grating structure, the electronic device may perform image signal amplification processing on the first image data, to avoid a case that insufficient light intensity causes poor clarity of a photographed image, thereby ensuring clarity of the third image obtained by the electronic device.

It should be noted that the image acquisition method provided in the embodiments of this application may be performed by an image acquisition apparatus, an electronic device, or a functional module or entity in the electronic device. In the embodiments of this application, the image acquisition apparatus provided in the embodiments of this application is described by using the image acquisition apparatus performing the image acquisition method as an example.

FIG. 10 is a possible schematic structural diagram of an image acquisition apparatus according to an embodiment of this application. As shown in FIG. 10, an image acquisition apparatus 70 may include an acquisition module 71 and a processing module 72.

The acquisition module 71 is configured to: control a grating structure of a camera module to diffract a first portion of incident light to a second photosensitive layer of an image sensor, and acquire first image data by using the image sensor; and control the grating structure to transmit a second portion of the incident light to a first photosensitive layer of the image sensor, and acquire second image data by using the image sensor. The processing module 72 is configured to obtain third image data based on the first image data and the second image data that are acquired by the acquisition module.

In a possible implementation, the acquisition module 71 is configured to: determine a first grating constant based on a wavelength of the first portion of the incident light and an incident angle and a diffraction angle of the first portion of the incident light on the grating structure; and adjust a grating constant of the grating structure to the first grating constant, so that the grating structure diffracts the first portion of the incident light to the second photosensitive layer.

In a possible implementation, the first photosensitive layer includes green pixel units, and the second photosensitive layer includes red pixel units and blue pixel units. The first image data includes red-channel image data and blue-channel image data, and the second image data includes green-channel image data. The processing module 72 is configured to fuse the red-channel image data, the blue-channel image data, and the green-channel image data to obtain the third image data.

In a possible implementation, the processing module 72 is further configured to: before obtaining the third image data based on the first image data and the second image data, perform image signal amplification processing on the first image data to obtain fourth image data. The processing module 72 is configured to obtain the third image data based on the fourth image data and the second image data.

This embodiment of this application provides an image acquisition apparatus. During image acquisition, the grating structure is controlled to diffract a first portion of incident light to a second photosensitive layer of the image sensor, and first image data is acquired, and the grating structure is controlled to transmit a second portion of the incident light to a first photosensitive layer of the image sensor, and second image data is acquired. Finally, third image data may be obtained based on the first image data and the second image data. Because the third image data is generated by fusing the first image data and the second image data, clarity of a final image can be improved.

The image acquisition apparatus in this embodiment of this application may be an electronic device, or may be a component such as an integrated circuit or a chip in the electronic device. The electronic device may be a terminal, or a non-terminal device. For example, a mobile electronic device may be a mobile phone, a tablet computer, a notebook computer, a palmtop computer, an in-vehicle terminal device, a mobile Internet device (MID), an augmented reality (AR)/virtual reality (VR) device, a robot, a wearable device, an ultra-mobile personal computer (UMPC), a netbook or a personal digital assistant (PDA), or the like, or may be a server, a network attached storage (NAS), a personal computer (PC), a television (TV), a counter, a self-service machine, or the like. This is not limited in this embodiment of this application.

The image acquisition apparatus in this embodiment of this application may be an apparatus with an operating system. The operating system may be an Android operating system, an iOS operating system, or another possible operating system. This is not limited in the embodiments of this application.

The image acquisition apparatus provided in this embodiment of this application can implement the processes implemented in the foregoing method embodiments, and achieve a same technical effect. To avoid repetition, details are not described herein again.

Optionally, as shown in FIG. 11, an embodiment of this application further provides an electronic device 90, including a processor 91 and a memory 92. The memory 92 stores a program or instructions executable by the processor 91. When the program or instructions are executed by the processor 91, the processes of the foregoing embodiment of the image acquisition method are implemented, and a same technical effect can be achieved. To avoid repetition, details are not described herein again.

It should be noted that the electronic device in this embodiment of this application includes the foregoing mobile electronic device and the foregoing non-mobile electronic device.

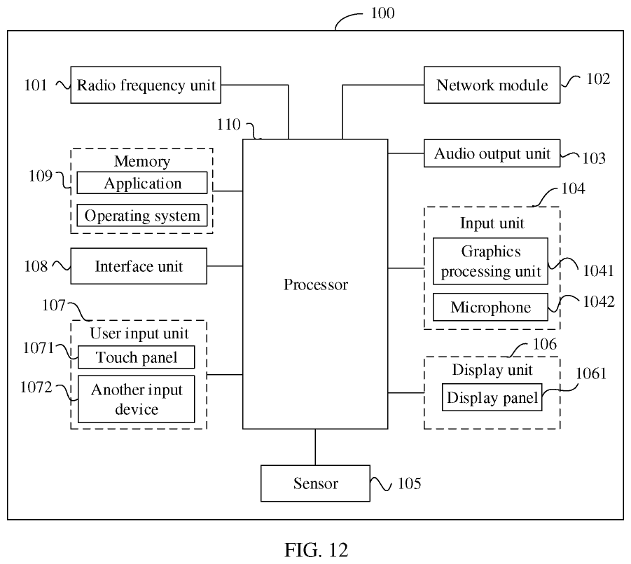

FIG. 12 is a schematic diagram of a hardware structure of an electronic device according to an embodiment of this application.

An electronic device 100 includes but is not limited to components such as a radio frequency unit 101, a network module 102, an audio output unit 103, an input unit 104, a sensor 105, a display unit 106, a user input unit 107, an interface unit 108, a memory 109, a processor 110, and a camera module. The camera module is the camera module in the foregoing embodiment.

A person skilled in the art can understand that the electronic device 100 may further include a power supply (such as a battery) that supplies power to each component. The power supply may be logically connected to the processor 110 by using a power supply management system, to implement functions such as charging and discharging management, and power consumption management by using the power supply management system. The structure of the electronic device shown in FIG. 12 does not constitute a limitation on the electronic device. The electronic device may include components more or fewer than those shown in the diagram, a combination of some components, or different component arrangements. Details are not described herein.

The processor 110 is configured to: control a grating structure of a camera module to diffract a first portion of incident light to a second photosensitive layer of an image sensor, and acquire first image data by using the image sensor; control the grating structure to transmit a second portion of the incident light to a first photosensitive layer of the image sensor, and acquire second image data by using the image sensor; and obtain third image data based on the first image data and the second image data.

This embodiment of this application provides an electronic device. During image acquisition, the grating structure is controlled to diffract a first portion of incident light to a second photosensitive layer of the image sensor, and first image data is acquired, and the grating structure is controlled to transmit a second portion of the incident light to a first photosensitive layer of the image sensor, and second image data is acquired. Finally, third image data may be obtained based on the first image data and the second image data. Because the third image data is generated by fusing the first image data and the second image data, clarity of a final image can be improved.

In some embodiments of this application, the processor 110 is configured to: determine a first grating constant based on a wavelength of the first portion of incident and an incident angle and a diffraction angle of the first portion of the incident light on the grating structure; and adjust a grating constant of the grating structure to the first grating constant, so that the grating structure diffracts the first portion of the incident light to the second photosensitive layer.

In some embodiments of this application, the first photosensitive layer includes green pixel units, and the second photosensitive layer includes red pixel units and blue pixel units. The first image data includes red-channel image data and blue-channel image data, and the second image data includes green-channel image data. The processor 110 is configured to fuse the red-channel image data, the blue-channel image data, and the green-channel image data to obtain the third image data.

In some embodiments of this application, the processor 110 is further configured to perform image signal amplification processing on the first image data to obtain fourth image data. The processor 110 is configured to obtain the third image data based on the fourth image data and the second image data.

The electronic device provided in this embodiment of this application can implement the processes implemented in the foregoing method embodiment, and can achieve the same technical effect. To avoid repetition, details are not described herein again.

For beneficial effects of the implementations in this embodiment, refer to the beneficial effects of the corresponding implementations in the foregoing method embodiment. To avoid repetition, details are not described herein again.

It should be understood that in this embodiment of this application, the input unit 104 may include a graphics processing unit (GPU) 1041 and a microphone 1042. The graphics processing unit 1041 processes image data of a static picture or a video obtained by an image capture apparatus (for example, a camera) in a video capture mode or an image capture mode. The display unit 106 may include a display panel 1061, and the display panel 1061 may be configured in a form of a liquid crystal display, an organic light-emitting diode, or the like. The user input unit 107 includes at least one of a touch panel 1071 and another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

The memory 109 may be configured to store a software program and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The nonvolatile memory may be a read-only memory (ROM), a programmable ROM (PROM), an erasable PROM (EPROM), an electrically EPROM (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 109 in this embodiment of this application includes but is not limited to these memories and any memory of another proper type.

The processor 110 may include one or more processing units. Optionally, an application processor and a modem processor are integrated into the processor 110. The application processor mainly processes an operating system, a user interface, an application, or the like. The modem processor mainly processes a wireless communication signal, for example, a baseband processor. It may be understood that, alternatively, the modem processor may not be integrated into the processor 110.

An embodiment of this application further provides a non-transitory readable storage medium. The non-transitory readable storage medium stores a program or instructions. When the program or instructions are executed by a processor, the processes of the foregoing method embodiments are implemented, with the same technical effects achieved. To avoid repetition, details are not described herein again.

The processor is a processor in the electronic device in the foregoing embodiment. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communications interface, the communications interface is coupled to the processor, and the processor is configured to run a program or an instruction to implement the processes of the foregoing method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program product. The program product is stored in a non-transitory storage medium, and the program product is executed by at least one processor to implement the processes of the foregoing embodiment of the image acquisition method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be mobile phone, a computer, a server, a network device, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A camera module, comprising a housing, a grating structure, an image sensor, and a reflection assembly; wherein
the grating structure, the image sensor, and the reflection assembly are disposed in the housing;
the image sensor comprises a first photosensitive layer and a second photosensitive layer that are stacked; and
the grating structure is disposed above the image sensor, and when incident light reaches the grating structure, a first portion of the incident light passes through the grating structure, and then reaches the first photosensitive layer of the image sensor, and a second portion of the incident light diffracts through the grating structure to the reflection assembly, and then reaches the second photosensitive layer of the image sensor after being reflected by the reflection assembly.

2. The camera module according to claim 1, wherein photosensitive units in the first photosensitive layer are disposed opposite to photosensitive units in the second photosensitive layer, a logic circuit layer is disposed between the first photosensitive layer and the second photosensitive layer, and the logic circuit layer is separately electrically connected to the first photosensitive layer and the second photosensitive layer.

3. The camera module according to claim 1, wherein the reflection assembly comprises a first reflection member and a second reflection member;
an angle between a plane of the first reflection member and a plane of the grating structure is less than 90°;
the second reflection member is disposed opposite to the second photosensitive layer; and
the second portion of the incident light diffracted by the grating structure reaches the second photosensitive layer after being successively reflected by the first reflection member and the second reflection member.

4. The camera module according to claim 1, wherein the grating structure comprises at least two liquid crystal assemblies, and a thickness of each of the liquid crystal assemblies is greater than or equal to 1 nm;
the size of the grating structure is greater than or equal to the size of the image sensor; and
the material of each of the liquid crystal assemblies is an electrochromic material.

5. The camera module according to claim 1, wherein the first photosensitive layer comprises green pixel units, and the second photosensitive layer comprises red pixel units and blue pixel units.

6. The camera module according to claim 2, wherein the first photosensitive layer and the second photosensitive layer comprise photodiodes;
the logic circuit layer comprises a signal output module, a first switch, a second switch, and a first capacitor;
an output terminal of each photodiode is connected to the signal output module, and the signal output module is connected to a first terminal of the first switch;
a second terminal of the first switch and a first terminal of the second switch are separately connected to a first terminal of the first capacitor, a second terminal of the first capacitor is grounded, and a second terminal of the second switch is connected to a power supply terminal; and
a voltage signal output by the signal output module is associated with a voltage signal generated by the corresponding photodiode and states of the first switch and the second switch.

7. An electronic device, wherein the electronic device comprises the camera module according to claim 1.

8. An image acquisition method, performed by the electronic device according to claim 7, wherein the image acquisition method comprises:
controlling the grating structure of the camera module to diffract the first portion of the incident light to the second photosensitive layer of the image sensor, and acquiring first image data using the image sensor; controlling the grating structure to transmit the second portion of the incident light to the first photosensitive layer of the image sensor, and acquiring second image data using the image sensor; and
obtaining third image data based on the first image data and the second image data.

9. The method according to claim 8, wherein the step of controlling the grating structure of the camera module to diffract the first portion of the incident light to the second photosensitive layer of the image sensor comprises:
determining a first grating constant based on a wavelength of the first portion of the incident light and an incident angle and a diffraction angle of the first portion of the incident light on the grating structure; and
adjusting a grating constant of the grating structure to the first grating constant, so that the grating structure diffracts the first portion of the incident light to the second photosensitive layer.

10. The method according to claim 8, wherein the first photosensitive layer comprises green pixel units, the second photosensitive layer comprises red pixel units and blue pixel units, the first image data comprises red-channel image data and blue-channel image data, and the second image data comprises green-channel image data; and
the step of obtaining third image data based on the first image data and the second image data comprises:
fusing the red-channel image data, the blue-channel image data, and the green-channel image data to obtain the third image data.

11. The method according to claim 8, wherein before the obtaining third image data based on the first image data and the second image data, the method further comprises:
performing image signal amplification processing on the first image data to obtain fourth image data; and
the step of obtaining third image data based on the first image data and the second image data comprises:
obtaining the third image data based on the fourth image data and the second image data.

12. An electronic device, comprising a processor, a memory, and a program or instructions stored in the memory and executable by the processor, wherein when the program or instructions are executed by the processor, the steps of the image acquisition method according to claim 8 are implemented.

13. A non-transitory readable storage medium, wherein the non-transitory readable storage medium stores a program or instructions, and when the program or instructions are executed by a processor, the steps of the image acquisition method according to claim 8 are implemented.

14. A chip, wherein the chip comprises a processor and a communication interface, the communication interface is coupled to the processor, and the processor is configured to run a program or instructions to implement the steps of the image acquisition method according to claim 8.
